(19) United States
(12) Patent Application Publication
(10) Pub. No.: US 2016/0327151 A1
(43) Pub. Date: Nov. 10, 2016

(54) METHOD FOR OPERATING A MOTOR VEHICLE

(71) Applicant: GM GLOBAL TECHNOLOGY OPERATIONS LLC, Detroit, MI (US)

(72) Inventor: Horst BACKES, Russelsheim (DE)

(73) Assignee: GM GLOBAL TECHNOLOGY OPERATIONS LLC, Detroit, MI (US)

(21) Appl. No.: 15/148,541

(22) Filed: May 6, 2016

(30) Foreign Application Priority Data
May 6, 2015 (DE) 102015005850.9

(51) Int. Cl. F16H 61/02; F16H 59/44

(52) U.S. Cl. CPC F16H 61/0213; F16H 59/44; F16H 2059/446; F16H 2063/426

(57) ABSTRACT

A method is disclosed for operating a motor vehicle with a manual transmission and a clutch that can be engage. According to the method, a vehicle standstill condition is detected; and a shifting instruction is output when a vehicle standstill has been detected and a gear position of the transmission determined for the vehicle standstill does not correspond to any transmission position of a predetermined drive-off transmission quantity.

### CROSS-REFERENCE TO RELATED APPLICATION

This application claims priority to German Patent Application No. 102015005850.9, filed May 6, 2015, which is incorporated herein by reference in its entirety.

### TECHNICAL FIELD

The present disclosure relates to a method for operating a motor vehicle with a manual transmission, a system and a computer program product for carrying out the method and to a motor vehicle, in particular a passenger car, with the system.

### BACKGROUND

When a driver in a motor vehicle approaches a stop, for example a traffic light, he or she regularly engages the clutch and brakes the vehicle to a standstill. For driving off again, the transmission should preferentially be shifted into a suitable, in particular the first gear. However, if the driver keeps the clutch engaged for example by pressing the clutch pedal, it can happen that a gear, which was last engaged when approaching the stop, for example a third gear, erroneously still remains engaged when driving off again.

### SUMMARY

According to an aspect of the present disclosure, a motor vehicle, in particular a passenger car, includes a manual or manually-shiftable transmission, in particular a manual-shift transmission and a clutch that can be engaged for example manually engaged by actuating a foot pedal, for operably coupling and uncoupling the transmission with or from a drive motor, such as an internal combustion engine and/or an electric motor.

According to an aspect of the present disclosure, a method for operating a motor vehicle is provided in which a vehicle standstill is detected, a shifting instruction is output when a vehicle standstill has been detected and a current gear position of the transmission for the vehicle at standstill does not correspond to a preferred gear position for driving off (e.g., a drive-off gear position).

In an embodiment, the risk that when driving off, in particular when driving off again following a previous vehicle standstill, an unsuitable gear is engaged, an engaged higher forward gear erroneously remains engaged when approaching a stop can be advantageously reduced through the at least partial automated output of a shifting instruction to suit requirement.

In an embodiment, a speed of the motor vehicle is detected in its longitudinal direction by at least one sensor and a vehicle standstill detected as soon as this speed undershoots a predetermined limit value, which in an embodiment is smaller than 5 km/h, in particular, amounts to at least substantially zero.

In an embodiment, the drive-off gear position can include a neutral position and/or an engaged first forward gear and/or a second forward gear and/or a reverse gear of the transmission. A neutral position of the transmission is defined in an embodiment in that a driveshaft and an output shaft of the transmission are separated from one another or are not coupled to one another in a rotationally fixed manner. In this regard, gear wheels of all transmission stages are out of engagement with one another and/or are rotationally moveable or loose with respect to shafts on which they are mounted. A first or lowest or slowest forward gear of the transmission in an embodiment is defined by a smallest or slowest transmission ratio between a driveshaft and an output shaft of the transmission in forward direction. A second or second lowest or second slowest forward gear of the transmission accordingly by a second smallest or second slowest transmission ratio in forward direction, a reverse gear accordingly by a transmission of a rotation of the driveshaft into a reverse rotation of the drive wheels of the vehicle.

In an embodiment where the drive-off gear position includes a neutral position of the transmission, no shifting instruction is output when it is determined that a neutral position of the transmission has been detected before the vehicle standstill engagement of the clutch, for at least some time, A sensor, on the transmission or a shifting device for the manual shifting of the transmission, may be used to monitor a neutral position of the transmission. No instruction is advantageously output in an embodiment when the driver on his own account is already shifting or has already shifted into the neutral position, from which he can engage a gear that is suitable for driving off again,

In an embodiment where the drive-off gear position includes an engaged first forward gear of the transmission, no shifting instruction is output in the case that an engaged first forward gear of the transmission is determined for the vehicle standstill. No instruction is advantageously output in an embodiment when the driver on his own account has already shifted into the first forward gear which is suitable for driving off again.

In an embodiment where the drive-off gear position includes an engaged second forward gear of the transmission, no shifting instruction is output in the case that an engaged second forward gear of the transmission is determined for the vehicle standstill. No instruction is advantageously output in an embodiment when the driver for driving off again has intentionally shifted into the second forward gear. In an alternative embodiment, the drive-off gear position does not include any second (slowest) or higher (faster) forward gear of the transmission, so that advantageously only a first forward gear is provided for driving off again in forward direction.

In an embodiment where the drive-off gear position includes an engaged reverse gear of the transmission, no shifting instruction is output in the case that an engaged reverse Gear of the transmission is determined for the vehicle standstill. No instruction is advantageously output in an embodiment when the driver for driving off again has intentionally shifted into the reverse gear. In an alternative embodiment, the drive-off gear position does not include a reverse gear of the transmission so that advantageously only the first forward gear is provided for driving off again.

In an embodiment, the current gear position is directly detected by way of suitable sensors on the transmission or a shifting device for manually shifting the transmission and determined as gear position of the transmission for the vehicle standstill, unless a neutral position is detected, which in a further development is then determined as gear position of the transmission for the vehicle standstill instead of a detected engaged gear. In the alternative, if such sensors are not present, the current gear position of the transmission for the vehicle standstill according to an aspect of the present disclosure can also be determined based on a monitoring of a neutral position of the transmission and of an engaged gear which was last determined prior to detecting the vehicle standstill. For if no neutral position of the transmission is detected (any longer) after a last (in time) engagement of the clutch for detecting the vehicle standstill, it can be deduced that this last engaged gear continues to be engaged, and thus the current gear position.

Accordingly, in an embodiment the method includes detecting an engagement of the clutch before detecting the vehicle standstill. In particular monitoring of a neutral position of the transmission or if the transmission includes a neutral position, at least at times after the engaging the clutch or in particular shifting is (or has been) into the neutral position after the engagement of the clutch.

In an embodiment, the engagement of the clutch is detected by at least one sensor on the clutch or an actuating device for actuating the clutch. Additionally or alternatively a neutral position of the transmission is monitored in an embodiment by at least one sensor on the transmission or a shifting device for manually shifting the transmission, in particular a so-called neutral position sensor. The shifting device can include an actuating element, in particular a shift lever and/or a shifting, rod and/or a shifting cable and/or a guide, in particular a gate. The sensor in a further development can detect a position of a moveable member of the shifting device, of the shift lever, the shifting rod and/or of the shifting cable or can be equipped for this purpose.

In an embodiment, a drive-off gear position, in particular a neutral position is determined as the gear position of the transmission for the vehicle standstill in the case that after the last (in terms of time) detected engagement of the clutch which takes place before a detecting of the vehicle standstill has been detected, at least at times a neutral position of the transmission is or has been detected.

Additionally or alternatively an engaged gear, forward or reverse gear, which has last (in terms of time) been determined prior to the detecting of the vehicle standstill is determined as the gear position of the transmission for the vehicle standstill provided that following a last (in terms of time) engagement of the clutch which takes place prior to a detecting of the vehicle standstill has been detected, no neutral position is detected or has been detected (any longer). Here, the neutral position itself in terms of the present disclosure can be an engaged gear that was last (in terms of time) determined before the detecting of the vehicle standstill or be determined as gear position of the transmission for the vehicle standstill provided that before (in terms of time) a last engagement of the clutch which takes place has been detected before a detecting of the vehicle standstill, the neutral position itself is or has been detected last.

In other words, if the driver shifts into the neutral position, the clutch subsequently disengages without shifting into a forward or reverse gear beforehand and the clutch subsequently engages before the vehicle comes to a standstill, a neutral position in an embodiment is determined as gear position of the transmission for the vehicle standstill and thus no shifting instruction is output. If, by contrast, the driver engages the clutch last before the vehicle standstill while the transmission is in a forward or reverse gear, this gear position of the transmission is determined for the vehicle standstill and the shifting instruction output in the case that this engaged gear last determined prior to the detecting of the vehicle standstill does not correspond to the drive-off gear position, unless following the vehicle standstill last engagement of the clutch, a neutral position of the transmission is still detected.

Before detecting the vehicle standstill last engagement of the clutch in this case describes a last engagement of the clutch which in terms of time takes place, has been detected in terms of time (even) before detecting the vehicle standstill. In other words, a last engagement of the clutch (a last detected engagement of the clutch) preceding the detecting of the vehicle standstill.

A neutral position of the transmission which is detected after detecting the vehicle standstill last engagement of the clutch accordingly describes a neutral position which at least at times is detected after such a last engagement of the clutch, which in terms of time takes place, has been detected (even) before detecting the vehicle standstill.

An engaged gear determined last prior to the detecting of the vehicle standstill can in an embodiment be advantageously determined without using sensors, which determine directly a position of transmission members or a shifting device for manually shifting the transmission that is distinct from the neutral position of the transmission, without using sensors which detect a certain forward or reverse gear of the transmission, but for example instead by a comparison of drive rotational speed and output rotational speed of the transmission or the like.

In this way, as explained above, a gear position of the transmission for the vehicle standstill can be advantageously deduced by monitoring a neutral position based on a last engaged gear, since without assuming the neutral position of the transmission in the meantime the transmission continues to have the engaged gear determined last. Accordingly, the last engaged gear need not be directly detected but can be determined for example by a comparison of drive rotational speed and output rotational speed of the transmission or the like.

In an embodiment, the shifting instruction is output in the case that following a predetermined period of time from detecting the vehicle standstill the gear position of the transmission determined for the vehicle standstill does not yet correspond to a drive-off gear position. The predetermined period of time in an embodiment amounts to at least 0.1 second, in particular at least 0.5 seconds, in particular at least 1 second, in particular at least 2 seconds, and/or maximally 60 seconds, in particular maximally 30 seconds, in particular maximally in particular 10 seconds, in particular maximally in particular 5 seconds. Because of this, the driver, in an embodiment, can be advantageously granted adequate time for shifting into the neutral position or engaging a suitable gear for driving off again.

In an embodiment, the shifting instruction is visually output, on a shifting device for manually shifting the transmission and/or a display for displaying information, on an instrument panel and/or windshield of the motor vehicle, by displaying a shifting command such as for example “please engage first gear”, activating an illuminant such as an LED in a shift lever (knob) or the like. Additionally or alternatively the shifting instruction in an embodiment is output acoustically, by a warning sound and/or outputting of an acoustic shifting command such as for example “please engage first gear” or the like. Additionally or alternatively the shifting instruction in an embodiment is output haptically, by a moving shaking or vibrating of a shift lever, clutch pedal or the like.

Additionally or alternatively, the shifting instruction in an embodiment is output until a predetermined condition is fulfilled, a predetermined period of time has expired and/or a shifting into a neutral position of a neutral position and/or a driving off again of the vehicle has been detected. Because of this the shifting instruction, in an embodiment, can be omitted when the driver has taken the same into account or does not consciously follow the same.

According to an aspect of the present disclosure a system for operating the motor vehicle, in terms of hardware and/or program, is equipped for carrying out the methods described above. The system include at least one sensor or other means to detect a vehicle standstill and an output device configured to communicate a shifting instruction in the case that a vehicle standstill has been detected and a gear position of the transmission determined for the vehicle standstill does not correspond to a transmission position of a drive-off gear position.

In an embodiment, the system includes a sensor or other means to detect a last engagement of the clutch or to monitor a neutral position of the transmission. For example, at least one sensor may be on the transmission or a shifting device for manually shifting the transmission.

In an embodiment, the system includes a sensor or other means to determine a drive-off gear position, a neutral position, as gear position of the transmission, in the case that a neutral position of the transmission is detected after a before the detecting of the vehicle standstill last engagement of the clutch.

In an embodiment, the system includes a sensor or other means determine an engaged gear last determined before detecting the vehicle standstill as gear position of the transmission for the vehicle standstill in the case that no neutral position is detected after a before detecting the vehicle standstill last engagement of the clutch.

In an embodiment, the system includes an output device or other means to output the shifting instruction in the case that after a predetermined period of time from detecting the vehicle standstill the gear position of the transmission determined for the vehicle standstill does not correspond to any drive-off gear position.

In an embodiment, the output device may include a device for visually, acoustically and/or haptically indicating the shifting instruction. In particular, the output device may indicate the shifting instruction on a shifting device for manually shifting the transmission and/or a display for displaying information, on an instrument panel and/or windshield of the motor vehicle, and/or until a predetermined condition is fulfilled.

A means in terms of the present disclosure can be of hardware and/or software design, in particular include a digital processer in particular microprocessor unit (CPU) that is operably coupled to ask/rage device and/or bus system and further includes one or more programs or program modules, The CPU is configured in order to execute commands which are implemented as a program stored in a storage system, detect input signals from sensors in communication with a data bus and/or output signals to an output device in communication with the data bus. A storage system can include one or more different storage media, in particular visual, magnetic, solid-state and/or other non-volatile media. The program can be of such a type that it embodies or is capable to carry out the methods described above, so that the CPU can carry out the steps of such methods and thereby operate the motor vehicle.

### BRIEF DESCRIPTION OF THE DRAWINGS

The present disclosure will hereinafter be described in conjunction with the following drawing figures, wherein like numerals denote like elements.

FIG. 1 shows a motor vehicle with a system according to an embodiment of the present disclosure; and

FIG. 2 is a flow chart representing a method according to an embodiment of the present disclosure.

### DETAILED DESCRIPTION

The following de ailed description is merely exemplary in nature and is not intended to limit the invention or the application and uses of the invention. Furthermore, there is no intention to be bound by any theory presented in the preceding background of the invention OF the following detailed description.

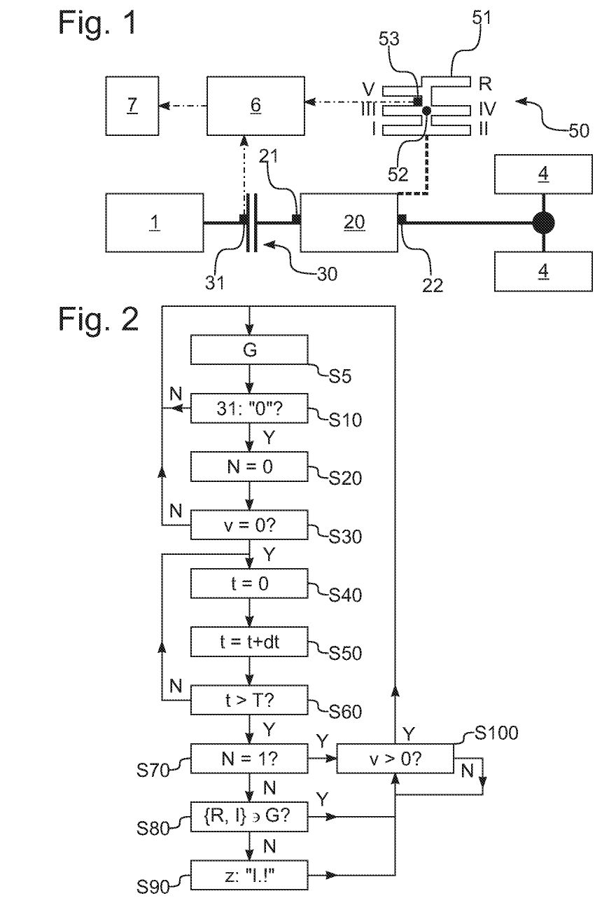

FIG. 1 shows a motor vehicle with a system according to an embodiment of the present disclosure. The motor vehicle includes an internal combustion engine 1 and a manual-shift transmission 20 for driving drive wheels 4, which can be coupled to the internal combustion engine 1 by means of a clutch 30. A shifting device 50 for manually shifting the transmission 20 includes a shifting gate 51 in which a shift lever 52 is guided.

The system includes an ECU 6, a display 7, a sensor 31 for detecting an engagement of the clutch 30, sensors 21, 22 for detecting a drive speed and an output rotational speed of the transmission 20 and a neutral position sensor 53 for detecting a neutral position of the transmission 20. The ECU carries out a method according to an embodiment of the present disclosure explained in the following with reference to FIG. 2 or is equipped to do so.

In a first step S5 the ECU 6 determines, continuously or periodically, an engaged gear G by comparing drive rotational speed and output rotational speed of the transmission 20 by means of the information of the sensors 21, 22. Here, a neutral position of the transmission that is detected by the neutral position sensor 53 can also be an engaged gear G.

In a step S10, the ECU 6 checks by means of information from sensor 31, if the clutch 30 is or has been engaged (“1”) or disengaged (“0”). For as long as the clutch 30 is disengaged (S10: “N”), the ECU repeats the consecutive steps S5 and 10.

In the case that the clutch 30 is engaged (S10: “Y”) a marker N is initialized in a step S20 which indicates that no neutral position of the transmission 20 has been detected yet (N=0). The last engaged gear G determined in the preceding step S5 remains stored as unengaged gear last determined prior to a detecting of the vehicle standstill.

During the following steps, this marker N is inverted (N=1) in the case that the sensor 53 detects (at times) a neutral position of the transmission 20. The inverted marker N thus is an indication of a detection of a neutral position of the transmission 20 following a before detecting the vehicle standstill last engagement of the clutch.

In a step S30 following step S20, the ECU 6 checks for example based on information from sensor 22 if a vehicle speed v undershoots a predetermined limit value of for example 1 km/h. If this is not the case (S30: “N”), the method returns to step S5. Otherwise (S30: “Y”), a vehicle standstill is detected.

In a following step S40, the ECU 6 initializes a time counter which it increments in a step S50 by predetermined intervals dt for as long as a predetermined period of time T from detecting the vehicle standstill in step S30 has not expired (S60: “N”). As soon as the predetermined period of time T from detecting the vehicle standstill in step S30 is expired (S60: “Y”), the ECU 6 in a step S70 checks if the marker N meanwhile indicates that in the meantime a neutral position of the transmission 20 has been detected (N=1) or the marker N continues to indicate that no neutral position of the transmission 20 has been detected (yet) (N=0).

If the ECU 6 based on the marker N now determines that meanwhile a neutral position of the transmission 20 has been detected (S70: “Y”), it proceeds with step 110 otherwise (S70: “N”) with step S80. In step S80 the ECU 6 checks if the engaged gear G last determined prior to the detecting of the vehicle standstill was or is a neutral position, a reverse or a first forward gear (“G∈{R, I}”).

If this is the case (S80: “Y”), it likewise proceeds with step S100, otherwise (S80: “N”) with step S90 in which in display 7 a shifting instruction “I.!” is output which instructs the driver to shift into the first forward gear. Following step 890, the method or the ECU 6 proceeds with step S100.

In this step S100, it is checked if the vehicle continues to be stationary (S100: “N”) or not (S100: “Y”). As soon as the vehicle is no longer stationary (S100: “Y”), the method or the ECU returns to step S5 and waits for a renewed engagement of the clutch 30.

Thus, a shifting instruction “I.!” is output in step S90 in the case that a vehicle standstill has been detected (S30: “Y”) and a gear position of the transmission determined for the vehicle standstill neither corresponds to a neutral position of the transmission (S70: “N”) (at times) nor a reverse or first forward gear that is engaged (last prior to engagement the clutch 30) (S80: “N”) and thus the gear position of the transmission determined for the vehicle standstill does not correspond to any transmission position of a drive-off gear position, which includes the neutral position, the engaged first forward gear and reverse gear of the transmission.

In other words, with the vehicle stationary following expiration of the predetermined period of time T, the shifting instruction is output when neither shifting into the neutral position has been carried out after the last engagement of the clutch 30 (in order to shift into the advantageous first forward gear for driving off again) nor the reverse or the first forward gear or the neutral position was last engaged before the last engagement of the clutch 30.

Here, engaging or shilling into a first forward gear includes a preceding neutral position or a preceding shifting through the neutral position of the transmission.

Thus, the gear position of the transmission, in the exemplary embodiment, for the vehicle standstill is determined based on a monitoring of the neutral position of the transmission (N=1?) and of an engaged gear G, which was last determined prior to the detecting of the vehicle standstill. This last engaged gear G can be determined without using sensors, which directly detect a forward or reverse gear, for example instead by a comparison of driving rotational speed and output rotational speed of the transmission 20 by means of the information of the sensors 21, 22 and thus advantageously by means of sensors that are present or useable for other purposes.

Thus, when a driver with the vehicle for example rolls towards a traffic light, the clutch 30, with third forward gear engaged, engages and the vehicle subsequently brakes to the standstill without shifting in the meantime from the third forward gear and thus at least at times into the neutral position, the shifting instruction is output after expiration of the predetermined period of time T since the third forward gear that continues to be engaged is unsuitable for driving off.

If by contrast the driver following the last engagement of the clutch 30 shifts into the neutral position, for example when engaging the first forward gear, no shifting instruction is output. Even when the driver already rolls towards the traffic light with engaged first forward gear or in the neutral position of the transmission, the clutch 30 opens and the vehicle subsequently brakes to the standstill, no shifting, instruction is output.

While at least one exemplary embodiment has been presented in the foregoing, detailed description, it should be appreciated that a vast number of variations exist. It should also he appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A method for operating a motor vehicle with a manual transmission and a clutch that can be engaged comprising:
detecting a vehicle standstill condition;
determining a current gear position; and
outputting a shifting instruction when the vehicle standstill condition indicates the vehicle is stopping and the current gear position does not correspond to a drive-off gear position.
